(19) United States
(12) Patent Application Publication
(10) Pub. No.: US 2005/0176402 A1
(43) Pub. Date: Aug. 11, 2005

(54) Method of making an emergency telephone call and an automatic calling apparatus for making such call

(76) Inventors: Anthony Verloop, Hsichih City (TW); Alex Yuan, Taipei (TW)

Correspondence Address: NIKOLAI & MERSEREAU, P.A., 900 SECOND AVENUE SOUTH, SUITE 820, MINNEAPOLIS, MN, 55402, US

(21) Appl. No.: 10/776,116

(22) Filed: Feb. 11, 2004

(51) Int. Cl. H04M 11/04

(52) U.S. Cl. 455/404.1; 340/531

(57) ABSTRACT

A method of making emergency telephone calls through the mobile communications system to the nearest emergency service unit and the automatic calling apparatus for making such call are provided, wherein the emergency call is transmitted through a mobile communications network, and a list of useful emergency service units with telephone numbers and area codes is kept by the above apparatus. The emergency service units may be distributed across different districts, and the automatic calling apparatus is still able to keep track of the current location of the user dynamically through the regular line connection with the mobile communications network and matching with a local area code. When the emergency button is pressed, an emergency call will be sent out to the nearest emergency service unit, thus the call-response time can be well controlled for making a rapid response.

### BACKGROUND OF THE INVENTION

1. Field of the Invention

The present invention is related to a method of making an emergency telephone call and an automatic calling apparatus for making such a call, and more particularly to an auto-dialing system that enables a person to make an emergency call to the nearest emergency service unit, such that a rapid rescue operation can be made to a person in need.

2. Description of Related Art

Through the advancements in the medical field, the life expectancy of human beings has noticeably improved over the past decades. Longevity is now commonly seen among the senior citizens, whereas this secret had been aspired to by many but bestowed to a few in a traditional society. The enforcement of birth control by many modern families has had a significant impact on the composition of the population. As people born in the baby boom era are reaching their middle-age, more medical resources need to be directed to the health care of this post-WWII generation. But ironically, many senior citizens either forced or voluntarily, choose to live in solitude rather than staying with their younger generations. If they suffer from chronic diseases, most of them will experience varying degrees of difficulty with body movements and will be unable to manage themselves without outside assistance, for example, calling for a doctor or ambulance when their health is in an acute condition.

Accordingly, some manufacturers have come up with a portable auto-dialer that enables the patients to make an emergency call by the pressing of a button. These auto-dialers, in a portable form, can transmit an urgent message to a data control center, which will dispatch an ambulance to the location of the caller when an urgent message is received. Since the location of the data control center is fixed, if the patient travels to a place far away from the data control center, the urgent message is still sent back to the data control center. In that case, it will take some time before the rescue personnel and the ambulance can reach the caller, and the patient's health condition may deteriorate further while waiting for the rescue personnel and equipment to arrive. Therefore, the conventional auto-dialer needs to be further modified to prevent such critical delays.

### SUMMARY OF THE INVENTION

The main object of the present invention is to provide a method of making an emergency telephone call to the nearest emergency service unit, such that a rapid rescue operation can be made to a person in need.

To this end, the instrumentalities of the present invention include the acts of:
preparing a portable automatic calling apparatus for a person who has difficulties with body movement;
saving the telephone numbers of several useful emergency service units, with the area codes of the service units, in the memory of the automatic calling apparatus;
establishing a regular line connection to the mobile communications network using the automatic calling apparatus whenever the person moves from one place to another, especially across the district boundaries;
extracting the area code information from an initialization message of the mobile communications network;
searching through the memory records to locate an emergency service unit with the same area code; and
transmitting an emergency call through the mobile communications network to the emergency service unit having the same area code when the emergency button on the apparatus is pressed by the caller.

According to the first aspect of the present invention, the automatic calling apparatus is an auto-dialer that uses radio frequencies to transmit signals through a GMS/GPRS mobile communications network, which will be further explained through the second aspect of the present invention.

Also, the automatic calling apparatus can be designed with a portable form for fastening onto the person's body, so whenever the person moves about the portable apparatus will always accompany the person to a new location.

Also, the automatic calling apparatus is able to update the patient's location dynamically Whenever the patient's health is in an acute situation that urgent medical care is required, the patient simply needs to press down the emergency button, and an emergency call will be directed to the nearest emergency service unit to request medical care or other rescue needs, thus shortening the call-response time for making a rapid rescue operation.

Also, the list of emergency service units kept in the memory records of the emergency calling apparatus may contain service units distributed across districts with different area codes.

Also, the above mobile communications network is a GSM/GPRS system operated with cellular communications equipment.

Also, the above call receiver can be hospitals, ambulance operators, rescue operation center, police stations, fire brigades, family doctor or related persons.

The second object of the present invention is to provide an automatic calling apparatus that is capable of using radio frequency transmission to send an urgent message through the mobile communications network to the nearest emergency service unit.

To this end, the configuration of the automatic calling apparatus comprises:
a microprocessor serving as a control hub, where one input is connected to an emergency call button;
a memory module connected to the microprocessor for saving operation data, including the telephone numbers and area codes of the emergency service units, and the program instructions; and
a mobile communications interface connected to the microprocessor for linking to a mobile communications network.

According to the second aspect of the present invention, when a person wearing the automatic calling apparatus moves to a new place, the calling apparatus is activated to update the person's location. The apparatus first establishes a regular line connection to the mobile communications network. Through the system initialization process, the microprocessor of the above apparatus extracts the local area code information from the initialization message of the mobile communications network, and then use that information to search through the memory records to locate an emergency service unit with the same area code, which also represents the closest emergency service unit. When the emergency call button is pressed, the microprocessor initiates an emergency call according to the telephone number provided by the memory record with matching area code, and the call is always sent to the nearest emergency service unit, thus the call-response time can be well controlled for making a rapid rescue operation.

Also, the above mobile communications interface can be a GSM/GPRS communications module.

Also, the above automatic calling apparatus can be incorporated in a personal computing device.

Also, the personal computing device can be a notebook, a flat panel computer and a personal digital assistant (PDA).

Also, the above automatic calling apparatus can also be incorporated in a repeater that has a diverse communications interface linking to different network systems through a computer.

Other objectives, advantages and novel features of the invention will become more apparent from the following detailed description when taken in conjunction with the accompanying drawings.

### BRIEF DESCRIPTION OF THE DRAWINGS

FIG. 1 is a block diagram of the system architecture of the present invention; and

FIGS. 2A-2D show a circuit diagram of the emergency calling apparatus incorporated in a repeater as implemented by one preferred embodiment.

### DETAILED DESCRIPTION OF THE PREFERRED EMBODIMENT

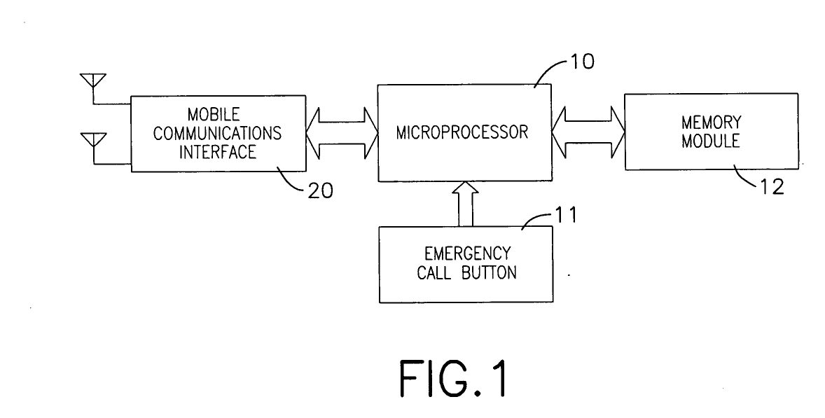

In the following description the user is referred to as a patient, however it is to be appreciated that the user may be physically or mentally challenged, a child too young to understand numbers or telephone use, simply a person who appreciates the instant call-making when needing to take care of a person in a life-threatening situation, etc. An automatic calling apparatus, as shown in FIG. 1, adopts a portable design for fastening onto a patient's body, and enables the patient to make an emergency call to the nearest emergency service unit for urgent medical care. The configuration of the automatic calling apparatus includes:
a microprocessor (10) being used for data processing and serving as a control hub, where one input is connected to an emergency call button (11);
a memory module (12) being connected to the microprocessor (10), for saving the operation data, including the telephone numbers and area codes of the useful emergency service units, and program instructions;
a mobile communications interface (20) being connected to the microprocessor (10), through which a line connection can be established with the mobile communications network.

The mobile communication interface (20), in the present example, is a GSM/GPRS communications module for linking to a GSM/GPRS mobile communications network.

A method that enables a patient to make an emergency call to the nearest emergency service unit is proposed, comprising the steps of:
preparing the above portable automatic calling apparatus, as explained in the above section, for fastening onto the patient's body;
saving the telephone numbers of several useful emergency service units, with the area codes of the service units, in the automatic calling apparatus;
establishing a regular line connection to the mobile communications network using the portable automatic calling apparatus whenever the patient moves about from one place to another, especially when crossing over into another district;
extracting the area code information from an initialization message of the mobile communications network;
searching through the memory records to locate an emergency service unit with the same area code; and
transmitting an emergency telephone call through the mobile communications network to the emergency service unit having the same area code when the emergency button on the apparatus is pressed by the patient.

The above mentioned mobile communications interface (20) uses radio frequencies to transmit voice and data signals through the GSM system operated with cellular communications system. The cellular communications system usually uses a number of low-power relay stations covering a large area instead of using a high-power transmitter. The GSM mobile phone or equivalent apparatus makes a connection to the mobile communications network, enabling voice and data signals to be routed through several local relay stations across different districts to reach the remote call receiver.

Therefore, when the emergency calling apparatus of the present invention is connected to the mobile communications network, it will receive an initialization message carrying the area code information of the local relay station. The microprocessor (10) then extracts the area code information and uses that information to search through the memory records saved in the memory module (12) to locate an emergency service unit having the same area code.

Whenever the patient's health is in an acute condition, regardless of the location of the patient and the district, if the patient presses down the emergency call button (11), the microprocessor (10) of the automatic calling apparatus will pick out an emergency service unit with the area code the same as that of the local relay station, and use the telephone number with a matching area code to make an emergency call through the mobile communications interface (20) to the nearest emergency service unit for urgent medical care or other rescue needs.

Depending on the applications and intentions of the user, appropriate call receivers may be hospitals, ambulance operators, rescue operation centers, family doctors, police stations, fire brigades or related persons.

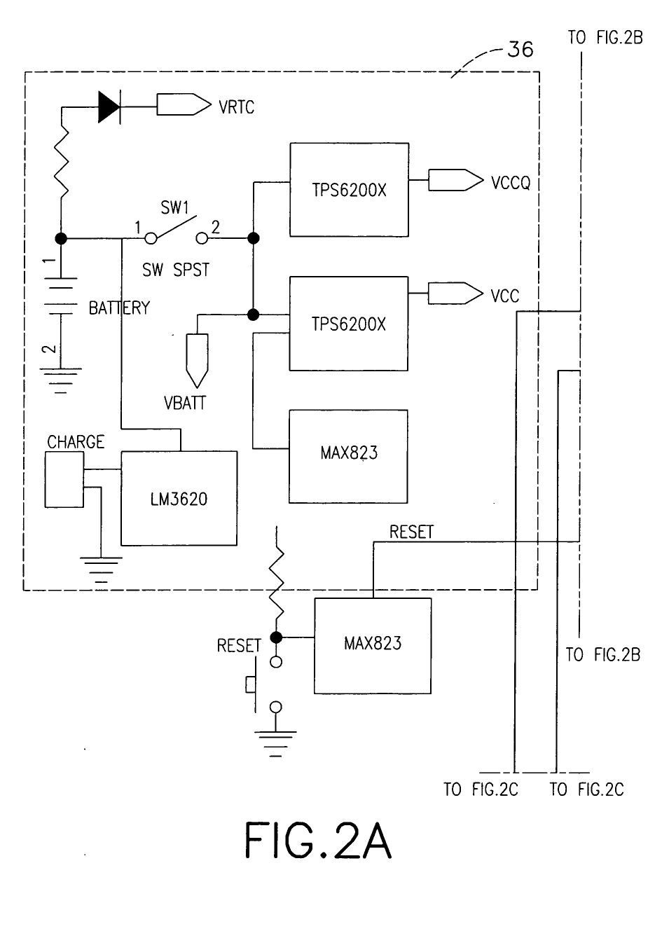

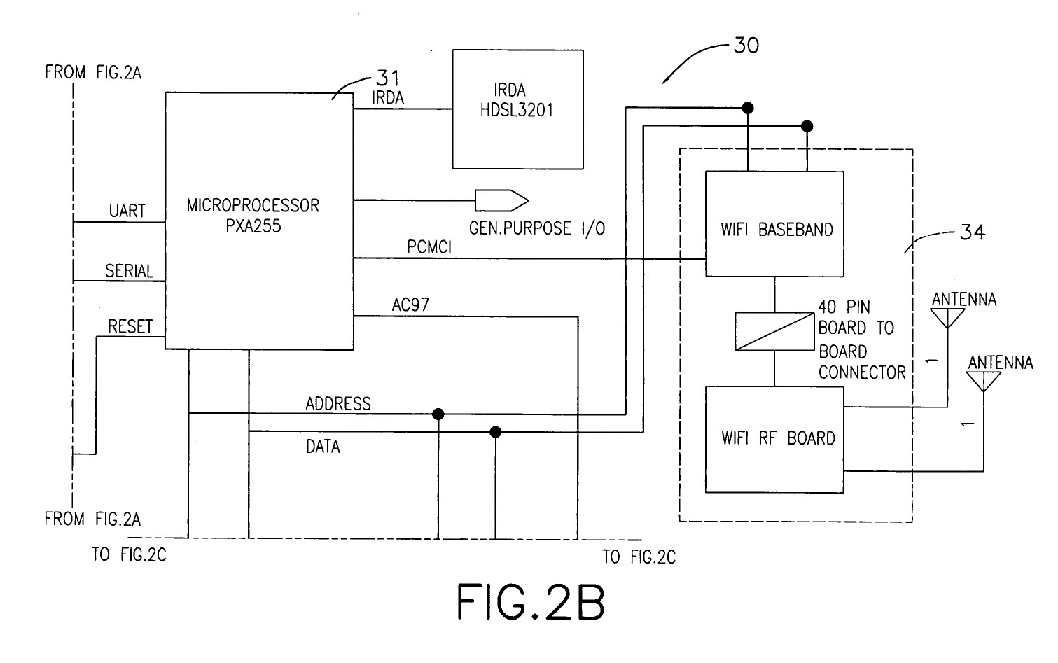

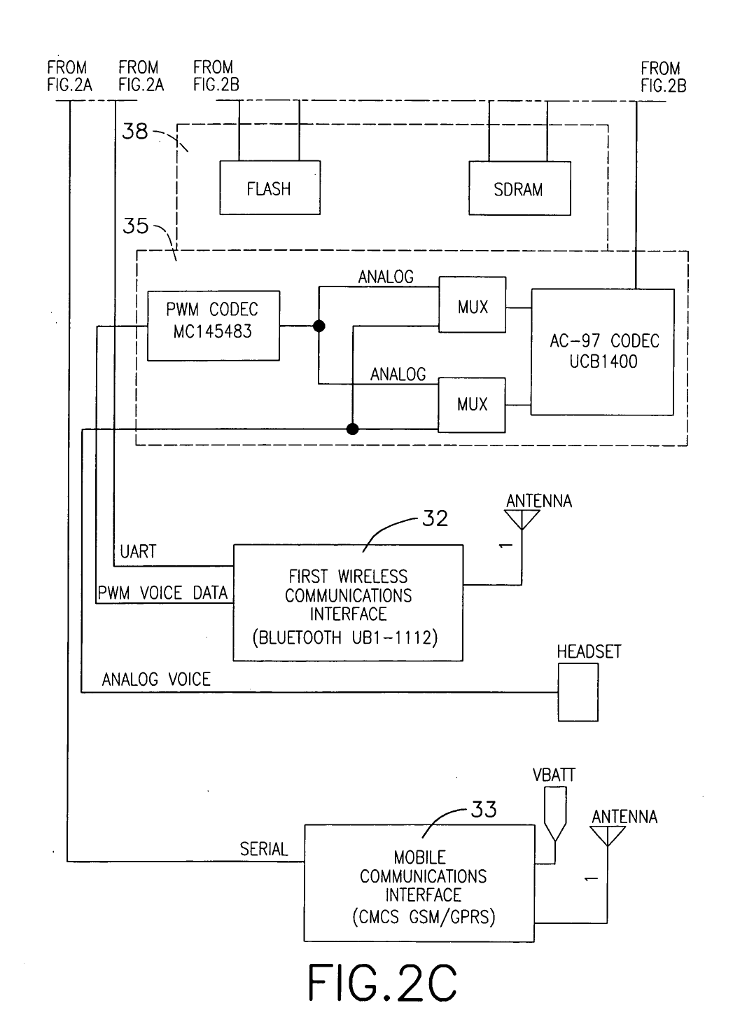

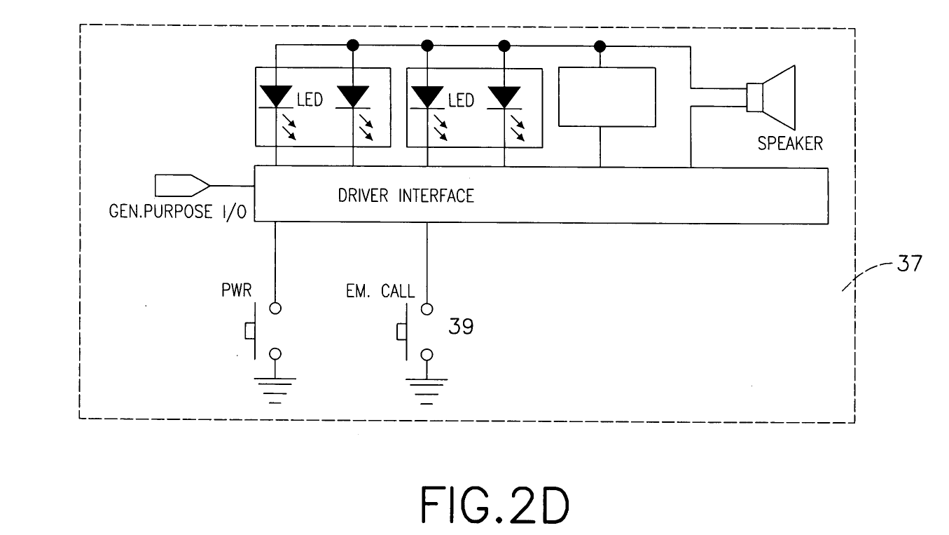

From the above description, the automatic calling apparatus of the present invention can be designed with a portable form for fastening onto the patient's body. Alternatively, the apparatus can be incorporated in a personal computing device such as a personal computer, a notebook computer, a flat panel computer, or a personal digital assistant (PDA). Also, the apparatus can be incorporated in a repeater (30) that has a diverse communications interface linking to different network systems through a computer, as demonstrated by the example in FIGS. 2A-2D.

The required structure of the automatic calling apparatus includes a microprocessor (31), a memory module (38), a first wireless communications interface (32), a mobile communications interface (33), a second wireless communications interface (34), a CODEC interface (35), a power supply module (36) and a prompter (37).

The microprocessor (31) is connected to the memory module (38), serving as a control hub.

The first wireless communications interface (32), which can be a Bluetooth module, is used for making connection between the personal computing device and the repeater.

The mobile communications interface (33), a GMS communications module, is connected to the microprocessor (31) for establishing a line connection with the mobile communications network.

The second wireless communications interface (34), a transceiver for a wireless local area network (WLAN), is connected to the microprocessor (31) for establishing a line connection with the wireless local area network (WLAN).

The CODEC interface (35), connected in between the first wireless communications interface (32) and the microprocessor (31) is needed for encoding and decoding voice and data signals in the signal transmission path.

The power supply module (36) is to provide operating voltages for all the internal components.

The prompter (37) is connected to the microprocessor (31), which is used to generate vibrations, ringing tones or light beams to alert the patient when the repeater (30) dropped the line connection with the WLAN.

It shall be noted that the microprocessor (31), the memory module (38), and the mobile communications interface (33) incorporated in the repeater (30) are similar to the corresponding components used in the portable automatic calling apparatus and provide the same functions, where the portable automatic calling apparatus also has a microprocessor (10), a memory module (12) and a mobile communications interface (20) as illustrated by the previous section.

The prompter (37) in the repeater (30) further includes an emergency call button (39), which has the same function as the emergency call button (11) found in the automatic calling apparatus, for making an emergency call.

From the foregoing, the automatic calling apparatus, either as a portable device or incorporated in a personal computing device or a repeater, enables a patient to make an emergency telephone call through the mobile communications network to the nearest emergency service unit, and the above apparatus is able to update the location of the patient automatically by extracting the area code information from the initialization message of the mobile communications network, and to use that information to search through the memory records saved in the apparatus to locate an emergency service unit having the same area code, so that the emergency call can always be forwarded to the nearest emergency service unit even when the patient moves to a new place in a different district, thus the call-response time can be well controlled for making a rapid rescue operation.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1. A method of making an emergency telephone call through the mobile communications system, comprising the steps of:
preparing a portable automatic calling apparatus for fastening onto a user's body;
saving telephone numbers of call receivers, with the area codes of the receivers, in memory records created in the automatic calling apparatus;
establishing a regular line connection to a mobile communications network using the portable automatic calling apparatus whenever the user moves about from one place to another, especially when crossing over district boundaries;
extracting local area code information from an initialization message of the mobile communications network;
searching through memory records to locate a call receiver with the same area code; and
transmitting an emergency call through the mobile communications network to a nearest call receiver having the same area code when the emergency button on the apparatus is pressed;
whereby when the user moves to a different district, the apparatus is still able to update the location of the user and pick out a nearest call receiver to dial.

2. The method of making an emergency telephone call according to claim 1, wherein the mobile communications network is operated with cellular communications equipment.

3. The method of making an emergency telephone call according to claim 2, wherein the cellular communications equipment is based on a GSM/GPRS system.

4. The method of making an emergency telephone call according to claim 1, wherein the call receiver is a hospital.

5. The method of making an emergency telephone call according to claim 1, wherein the call receiver is an ambulance operator.

6. The method of making an emergency telephone call according to claim 1, wherein the call receiver is a rescue operation center.

7. The method of making an emergency telephone call according to claim 1, wherein the call receiver is a police station.

8. The method of making an emergency telephone call according to claim 1, wherein the call receiver is a fire brigade.

9. The method of making an emergency telephone call according to claim 1, wherein the call receiver is a family doctor.

10. The method of making an emergency telephone call according to claim 1, wherein the call receiver is a related person of the user.

11. An automatic calling apparatus, comprising:
a microprocessor (10) being used for data processing and serving as a control hub, where one input is connected to an emergency call button (11);
a memory module (12) being connected to the microprocessor (10) for saving operation data, including the telephone numbers and area codes of call receivers, and program instructions; and
a mobile communications interface (20) being connected to the microprocessor (10), which is a GSM/GPRS communications module for linking to a mobile communications network;
whereby the automatic calling apparatus, attached to the user, changes the location whenever the user moves from one place to another, and the apparatus is able to establish regular line connection with the mobile communications network through the mobile communications interface (20), such that the microprocessor (10) can extract local area code information of the mobile communications network and use that information to search through memory records to locate a nearest call receiver with the same area code, and when the user actuates the emergency button (11), the microprocessor (10) uses the telephone number of the nearest call receiver to dial.

12. The automatic calling apparatus according to claim 11, wherein the mobile communications interface is a GSM/GPRS communications module.

13. The automatic calling apparatus according to claim 11, wherein the automatic calling apparatus is installed in a personal computing device.

14. The automatic calling apparatus according to claim 13, wherein the personal computing device is a notebook computer.

15. The automatic calling apparatus according to claim 13, wherein the personal computing device is a flat panel computer.

16. The automatic calling apparatus according to claim 13, wherein the personal computing device is a personal digital assistant (PDA).

17. The automatic calling apparatus according to claim 11, wherein the automatic calling apparatus is incorporated in a repeater that has a diverse communications interface linking to different network systems through a personal computing device.
